(19) United States
(12) Patent Application Publication
(10) Pub. No.: US 2017/0007999 A1
(43) Pub. Date: Jan. 12, 2017

(54) APPARATUS FOR DETERMINING THE TEMPERATURE OF MICROFLUIDIC DEVICES

(71) Applicant: IKERLAN, S. COOP., Arrasate-Mondragón - Guipúzcoa (ES)

(72) Inventors: Iñigo Aranburu Lazcano, Arrasate-Mondragón - Guipúzcoa (ES); Javier Berganzo Ruiz, Arrasate-Mondragón - Guipúzcoa (ES); Jesús Miguel Ruano López, Arrasate-Mondragón - Guipúzcoa (ES)

(21) Appl. No.: 15/105,959

(22) PCT Filed: Dec. 18, 2013
(86) PCT No.: PCT/ES2013/070887

§ 371 Date: Jun. 17, 2016

(51) Int. Cl. B01L 7/00

(52) U.S. Cl. CPC B01L 7/52; B01L 2200/025; B01L 2200/147; B01L 2300/0816; B01L 2300/1883; B01L 2300/1822

(57) ABSTRACT

The present invention relates to an apparatus for determining the temperature of microfluidic devices and is comprised in the field of heating and cooling systems for reaction chambers in microfluidic devices where thermal cycling processes or reactions are performed at constant temperature.

### OBJECT OF THE INVENTION

The present invention relates to an apparatus for determining the temperature of microfluidic devices and is comprised in the field of heating and cooling systems for reaction chambers in microfluidic devices where thermal cycling processes or reactions are performed at constant temperature.

### BACKGROUND OF THE INVENTION

Point of Care (POC) diagnostic systems based on molecular diagnosis generally have an analyzing system (hereinafter machine) and a disposable cartridge or chip referred to as a microfluidic device.

The microfluidic device contains one or more reaction chambers, fluidic channels connecting them to one another and, also channels connecting with the fluidic inlets or outlets of the microfluidic device. Flow is controlled, inter alia, by means of valves that allow redirecting the flow of the fluidic samples through the suitable path inside the microfluidic device.

Biological reactions between different compounds take place in the reaction chambers. In order for the reactions to occur, it is sometimes necessary to raise the temperature of the chamber to a certain value, or to reduce it to a certain value, or to perform certain temperature cycles. In this latter case, the reaction is favored when transitions between different temperatures are rapid.

The machine must have the means necessary for heating and/or cooling the microfluidic device both for heating or cooling the chamber and for subjecting it to thermal cycles. When this heating, cooling or both processes are performed by contacting a hot or cold surface with the microfluidic device, the thermal coupling between them is essential for obtaining a repetitive and reproducible system.

Misalignment between the contacting surfaces can lead to significant differences in heat transmission which involves as a result the chemical reaction not being optimally performed, the efficacy thereof being reduced.

An object of this invention is an apparatus for determining the temperature of microfluidic devices according to a pre-established value by means of heating or by means of cooling, or by means of both processes, where said pre-established temperature value can be defined by means of a time-dependent function. Functions reproducing a certain periodic cycle in a certain time period are of particular interest.

### DESCRIPTION OF THE INVENTION

A first aspect of the invention is an apparatus, or also referred to as machine in this field of the art, intended for receiving a microfluidic device on which it acts, determining the temperature of either the entire microfluidic device or a region thereof.

The use of the term “determine” when it is indicated that the apparatus determines the temperature of the microfluidic device is understood to mean that in the event of a temperature value taken as the target value to be reached in the microfluidic device, the apparatus provides the means which allow the microfluidic device to reach said temperature value by either transferring heat to the device to heat it or by removing heat from the device to cool it.

The qualification that the apparatus is intended for determining the temperature of either the entire microfluidic device or a region thereof is also included. The first option is when the apparatus is capable of bringing the entire microfluidic device to a certain temperature. The second option corresponds to those cases in which it is only necessary to reach the target temperature in a certain zone, for example because it is in that zone of the microfluidic device where the reaction chamber that must be subjected to thermal treatment is located. In this case, it is possible for the microfluidic device to comprise a region suitable for contacting the apparatus such that the transfer through this region assures that said apparatus can determine the temperature of the zone of interest without the temperature having to be determined in the entire microfluidic device.

As indicated, the microfluidic device particularly has reaction chambers containing fluidic samples that must be at a certain temperature which will generally follow a function of time. The function established by the target temperature can be constant or variable, and it is of great interest when the function is variable and includes cycles that are repeated over time. This latter case has been identified as “cycling”.

When the function established by the target temperature is variable and incorporates steps, the apparatus according to the invention incorporates means assuring a very rapid temperature response in order to comply with the requirements of the change defined by the stepped function.

According to this first aspect of the invention, the apparatus comprises:
housing means suitable for receiving and holding the microfluidic device in a certain position and orientation such that in this position the essentially flat region of the microfluidic device establishes a certain reference plane.

The apparatus receives the microfluidic device and keeps it held in a certain position and orientation. The means receiving and holding the microfluidic device assure that the essentially flat region of the device through which the heat transfer is carried out to determine the temperature is located in a pre-established position. The surface of the apparatus that will interact with this region of the microfluidic device therefore approaches a position in which the heat transfer region of the microfluidic device is located. This flat region of the microfluidic device is what defines the reference plane that will be used to spatially distribute the remaining components of the apparatus as well as the movements thereof.

Nevertheless, when particular examples of the invention are later described with the support of the drawings, terms such as up, down, right or left with respect to the orientation shown in the drawings will be used for the sake of convenience although these absolute references may always be considered relative references depending on the plane defined by the flat region of the microfluidic device.
a movable module that is movable at least according to a direction X-X′ perpendicular to the reference plane, where the movement establishes at least one approaching position with respect to the microfluidic device and a separated position with respect to the microfluidic device, where this movable module comprises:
   a pressure element that is movable according to direction X-X′, where the movement is guided with respect to the movable module, and where said pressure element has clearance to allow being misaligned with respect to direction X-X′,
   a heat source located in the pressure element, where in the approaching position, the heat source comprises a contact surface suitable for being supported on the heat transfer region of the microfluidic device and transferring heat through said region,
   a compressible pressure spring located between the movable module and the pressure element such that when the movable module is located in the approaching position with respect to the microfluidic device, said spring is compressed, exerting force against the pressure element and said spring in turn applying pressure on the heat transfer region of the microfluidic device by means of the contact surface.

The apparatus comprises a movable module and the movable module in turn comprises a pressure element that is movable with respect to the module. The movable module adopts at least two end positions, the approaching position and the separated position. The approaching position is the position in which the apparatus allows contact between the contact surface of the heat source and the region of the microfluidic device and allowing heat transfer, and the separated position is the position in which said contact is preferably released, for example, to facilitate the removal of the microfluidic device.

During movement of the movable module from the separated position to the approaching position, the contact surface suitable for being supported on the heat transfer region of the microfluidic device contacts said region.

Given that the contact surface is linked with the pressure element through the heat source, the pressure element acts as a stop and pressure is therefore applied on the pressure spring located between the movable module and the pressure element.

As a result, after movement of the movable module ends, the pressure spring is compressed and this compression keeps applying force on the pressure element, the latter in turn applying force on the heat source and therefore on the contact surface located in said heat source. This force is what assures contact between the surfaces, i.e., the contact surface located in the heat source and the surface identified as the region of the microfluidic device suitable for receiving the contact surface of the apparatus according to the invention.

There are many factors that make it hard to correctly support the contact surface of the heat source in the region of the microfluidic device, impairing heat transfer. Manufacturing defects in the module, in the pressure element, in the holding means for holding the microfluidic device, in the flatness of the microfluidic device, are just some of the many causes that can give rise to the two surfaces through which heat transfer occurs to not be properly supported and to this heat transfer being drastically reduced.

To solve this problem, the invention establishes that the pressure element, guided in its movement in direction X-X′ with respect to the movable module, has clearance to allow being misaligned with respect to this same direction X-X′. Direction X-X′ is the direction perpendicular to the surface defined by the region of the microfluidic device with which the support surface contacts. Therefore, both surfaces intended for contacting one another are perpendicular to direction X-X′ with the exception of the possible positioning errors such as those the identified above. Given that the invention establishes that the pressure element has clearance to allow misalignment, the force of the pressure spring forces the support surface of the heat source located in the pressure element to find the most stable position, this most stable position being the complete support of the two flat surfaces: the support surface located in the heat source and the flat surface defined by the region of the microfluidic device. This most stable position is possible because if it involves misalignment of the pressure element, this misalignment is attained as a result of the clearance.

According to different embodiments, the invention allows raising the temperature of the microfluidic device, reducing said temperature, or in the most complex case, establishing alternating heating periods and cooling periods, giving rise to a thermal treatment cycle.

### DESCRIPTION OF THE DRAWINGS

The foregoing and other features and advantages of the invention will become clearer based on the following detailed description of a preferred embodiment, given only by way of non-limiting illustrative example in reference to the attached drawings.

FIG. 1 shows a first embodiment schematically showing a microfluidic device and a module belonging to the apparatus for determining temperature, where the other elements of this apparatus acting on the module or the casings have not been depicted to allow viewing the most relevant elements of this embodiment of the invention. The embodiment allows cooling the microfluidic device below room temperature.

FIG. 2 shows an exploded perspective view of the module of the first embodiment allowing viewing the elements which allow cooling the microfluidic device.

FIG. 3 shows a second embodiment schematically showing a microfluidic device and a module as in the preceding example. In this embodiment, the module contains heating units for heating microfluidic devices or a region thereof.

FIG. 4 shows an exploded perspective view of the module of the second embodiment allowing viewing the elements which allow heating the microfluidic device.

FIG. 5 shows a third embodiment schematically showing a microfluidic device and a module as shown in the preceding examples. In this embodiment, the module contains more complex units than in the preceding embodiments because they allow both heating and cooling, resulting in an apparatus suitable for thermal cycling.

FIG. 6 shows an exploded perspective view of the module of the third embodiment allowing viewing the elements which allow both heating and cooling the microfluidic device.

FIG. 7 shows a detail of the position of the resistors and of a temperature sensor according to the third embodiment.

FIG. 8 shows an embodiment in which the apparatus has coupling means for coupling with the fluidic inlets and outlets of the microfluidic device, as well as means for increasing the internal pressure in the chamber to deform the elastically deformable membrane and for this membrane to in turn cling to the contact surface to improve heat transfer.

### DETAILED DESCRIPTION OF THE INVENTION

According to the first inventive aspect, the present invention relates to a device for determining the temperature of a microfluidic device.

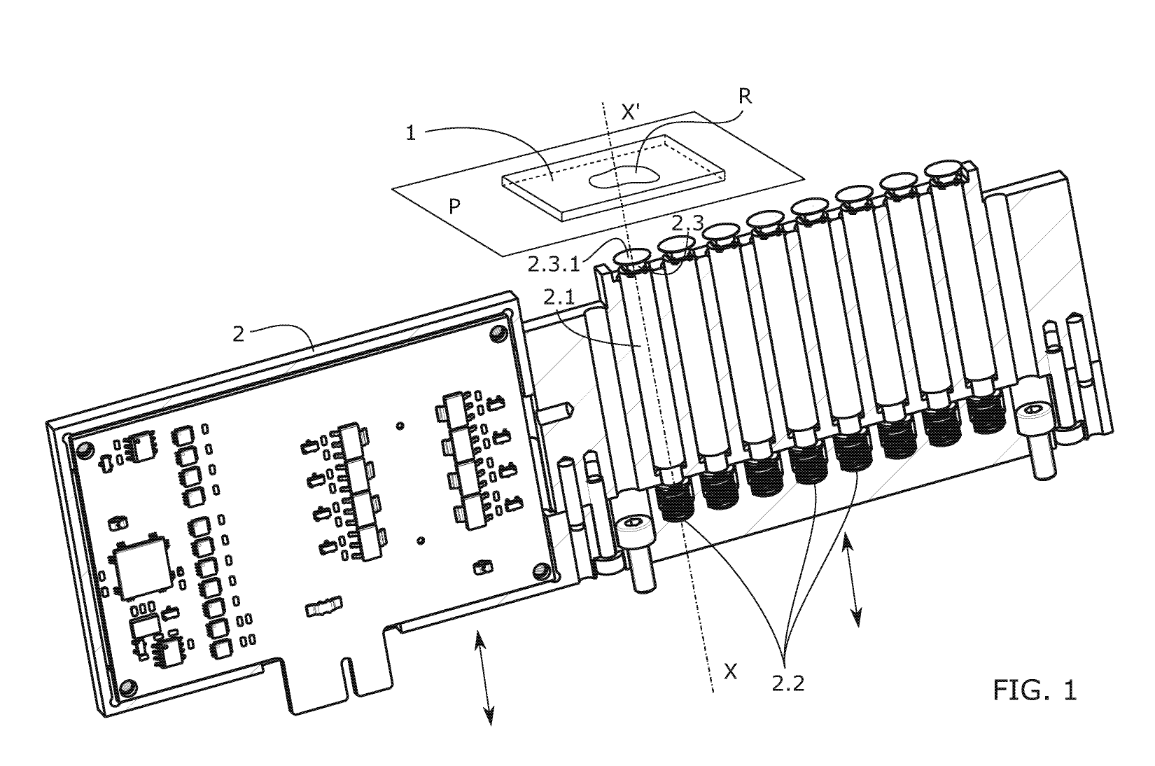

FIG. 1 shows an embodiment of an apparatus for cooling a plurality of microfluidic devices (1). FIG. 1 schematically shows just one microfluidic device (1) out of the plurality of microfluidic devices (1), and its graphical depiction has intentionally been enlarged to allow clearly viewing the aspects that are considered relevant. The cooling apparatus allows cooling a plurality of microfluidic devices (1) because it comprises a movable module (2) which in turn contains a plurality of cooling units, one per microfluidic device (1) to be cooled.

In an actual apparatus, each cooling unit in the movable module (2) of the apparatus acts on a microfluidic device (1). Although FIG. 1 shows a single enlarged microfluidic device (1) having a prismatic configuration primarily constituted as a rectangular plate with the orientation parallel to the larger side of the movable module (2), life-sized actual microfluidic devices (1) are preferably oriented parallel and transverse to the larger side of the movable module (2) to achieve a higher degree of packing. As indicated above, the graphical depiction of FIG. 1 has been chosen in order to clearly see the position of the region (R) to be cooled as well as the reference plane (P) determined by the main plane of the microfluidic device (1).

The cooling apparatus has holding means for holding the microfluidic device (1) in a position suitable for interacting with the unit which allows cooling either the microfluidic device (1) or a region (R) thereof. In this particular case, the region (R) to be cooled is an area arranged in the lower portion of the microfluidic device (1), considering the orientation shown in the drawing, where the region (R) to be cooled is a flat area defining the reference plane (R). This reference plane (P) allows defining the perpendicular direction graphically depicted by means of the X-X′ axis. This direction X-X′ is the direction in which the components of each of the cooling units located in the movable module (2) are distributed.

The movable module (2) is provided with a movement that attains at least two end positions, an approaching position with respect to the microfluidic device (1) and a separated position with respect to the same microfluidic device (1). The preferred movement attaining at least these end positions is a linear movement according to direction X-X′.

Given that the movable module (2) contains a plurality of cooling units, its movement causes the cooling units to move at the same time with respect to the microfluidic devices (1).

In the end separated position, the cooling unit does not contact the microfluidic device (1), and in the end approaching position, the cooling unit contacts the microfluidic device (1), enabling heat transfer; cooling the region (R) below room temperature in this embodiment.

Contact between the cooling unit and the region (R) occurs at an intermediate point of the movement between the end separated position and the end approaching position.

The cooling unit is formed by a pressure element (2.1) formed by a part having an essentially cylindrical configuration, which moves in a guided manner in an also cylindrical cavity inside the movable module (R). Cylindrical configuration is understood as that configuration containing a surface configured by means of a generatrix defined by a closed curve, where this generatrix defines the surface by movement along a path defined by a directrix. In the embodiments that will be described below, this cylindrical surface corresponds to a generatrix defined by a circumference, the shape of the section of the main body of the pressure element (2.1), and a straight directrix, the X-X′ axis.

There is a pressure spring (2.2) between the pressure element (2.1) and the movable module (2). During the movement of the movable module (2) from the end separated position to the end approaching position, once the cooling unit contacts the region (R) of the microfluidic device (1), the pressure spring (2.2) is compressed until attaining the highest degree of compression in the end approaching position.

The pressure element (2.1) has a heat source (2.3), where the heat source (2.3) in this embodiment comprises a Peltier cell located in the pressure element (2.1), at the end opposite to where the pressure spring (2.2) is located.

The heat source (2.3) comprises a contact surface (2.3.1) located on the Peltier cell. This contact surface (2.3.1) is the surface intended for contacting the region (R) of the microfluidic device with certain pressure determined by the compression of the pressure spring (2.2). The support between the two surfaces, i.e., the contact surface (2.3.1) and the region (R), is assured by providing the pressure element (2.1) with a clearance that allows it to be misaligned with respect to direction X-X′. The pressure between the two surfaces is what determines the orientation of the pressure element (2.1) and not the other way around, such that the pressure element (2.1) acts like a floating element which is oriented such that it always assures that the contacting surfaces are co-planar and, therefore, that heat transfer between both surfaces is optimal.

The orientation of the Peltier cell is suitable for heat to flow from the contact surface (2.3.1) towards the pressure element (2.1), thus cooling the contact surface (2.3.1) and the region (R) of the microfluidic device (1) when they are both in contact.

The pressure element (2.1) will be heated by the heat transferred by means of the Peltier cell from the region (R), and the greater the heat capacity and mass, i.e., the greater the thermal inertia, the less the temperature will increase.

In this embodiment, the pressure element (2.1) is suitable for transferring heat between the heat source (2.3) and the module (2) for increasing the thermal inertia and therefore the capacity for cooling the region (R) of the microfluidic device (R), such that said pressure element (2.1) is made of a heat conductive material and is guided by the sliding of a cylindrical perimetral surface over a complementary guiding surface arranged in the movable module (2), the contact between both surfaces being suitable for conducting heat.

An increase in the mass of the movable module (2) increases the cooling capacity given that it is capable of receiving more heat from the cooling units.

Another way to increase the cooling capacity, which can be combined with the increase in thermal inertia, is to incorporate cooling means in the movable module (2), for example, by means of dissipation fins, blowers or both. The heat discharged from the microfluidic device is thus transferred to the atmosphere and the cooling capacity is not limited by the thermal inertia of the components of the apparatus.

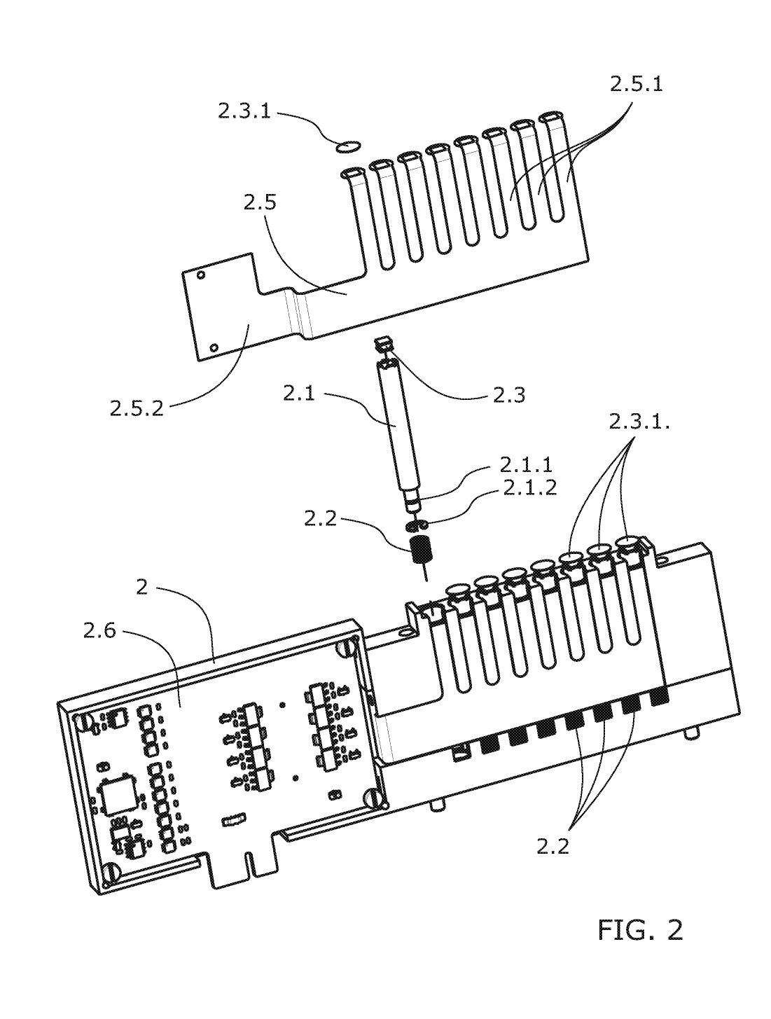

FIG. 2 shows an exploded perspective view of some of the components of the movable module (2) and of one of the cooling units, which is shown more to the left in the drawing.

In the details shown in said FIG. 2, the essentially cylindrical body of the pressure element (2.1) is seen, where at its lower end there is a notch (2.1.1) housing a circlip (2.1.2). The circlip (2.1.2) serves as a seating for the pressure spring (2.2). The pressure spring (2.2) is supported at one of its ends on the circlip (2.1.2) and at the other end on the bottom of the cavity housing the pressure element (2.1). The side wall of the cavity, having a cylindrical configuration, is the guide that allows the guided sliding of the pressure element (2.1) along direction X-X′.

The Peltier cell (2.3) is shown at the other end of the main body of the pressure element (2.1). The Peltier cell (2.3) has a contact surface (2.3.1) which is shown in the form of a metal plate in the exploded perspective view.

The Peltier cell (2.3), with its contact surface (2.3.1), is the heat source in this embodiment. The Peltier cell (2.3) is an active component that must be electrically powered. Given its relative movement with respect to the movable module (2), in this embodiment the power supply of the heat source (2.3) consists of a flexible printed circuit board (2.5) where one end is integral with the pressure element (2.1) and the other end is integral with the movable module (2) to establish electrical communication between the module (2) and said heat source (2.3) without impeding the relative movement between the module (2) and the heat source (2.3). The shape of the flexible printed circuit board (2.5) is that which has as many prolongations (2.5.1) as cooling units to be powered. The flexible printed circuit board (2.5) has an extension (2.5.2) which allows taking electric conduction terminals from an electronic management module (2.6) to each Peltier cell (2.3) through the prolongations (2.5.1).

This embodiment has a very simple configuration given that it does not have temperature sensors. The Peltier cells (2.3) of each cooling unit are powered, cooling the microfluidic devices (1). The temperature that is reached depends on the conditions of equilibrium and thermal inertias of each of the components of both the apparatus and the microfluidic device (1).

In one embodiment, the apparatus is used to carry out cooling at 4° C. for one hour, and subsequently cooling at a higher temperature of 10° C. for 30 minutes. It is understood that both temperatures are below room temperature, and given that the apparatus according to this embodiment does not have heating means, the temperature increase occurs because cooling is reduced. This embodiment is useful in those cases, for example, in which the transition time between temperatures, for example to go from 4° C. to 10° C., is irrelevant.

According to another embodiment, the metal plate forming the contact surface (2.3.1) has temperature sensors (2.7) connected with the electronic management module (2.6) by means of conducting tracks located in the flexible printed circuit board (2.5). These sensors (2.7) allow the electronic management module (2.6) to determine the input power of the Peltier cells (2.3) according to the temperature that is reached.

According to another embodiment, the orientation of the Peltier cells (2.3) is opposite that described such that heat flows towards the region (R) of the microfluidic device (1), and the apparatus therefore has a plurality of heating units instead of a plurality of cooling units.

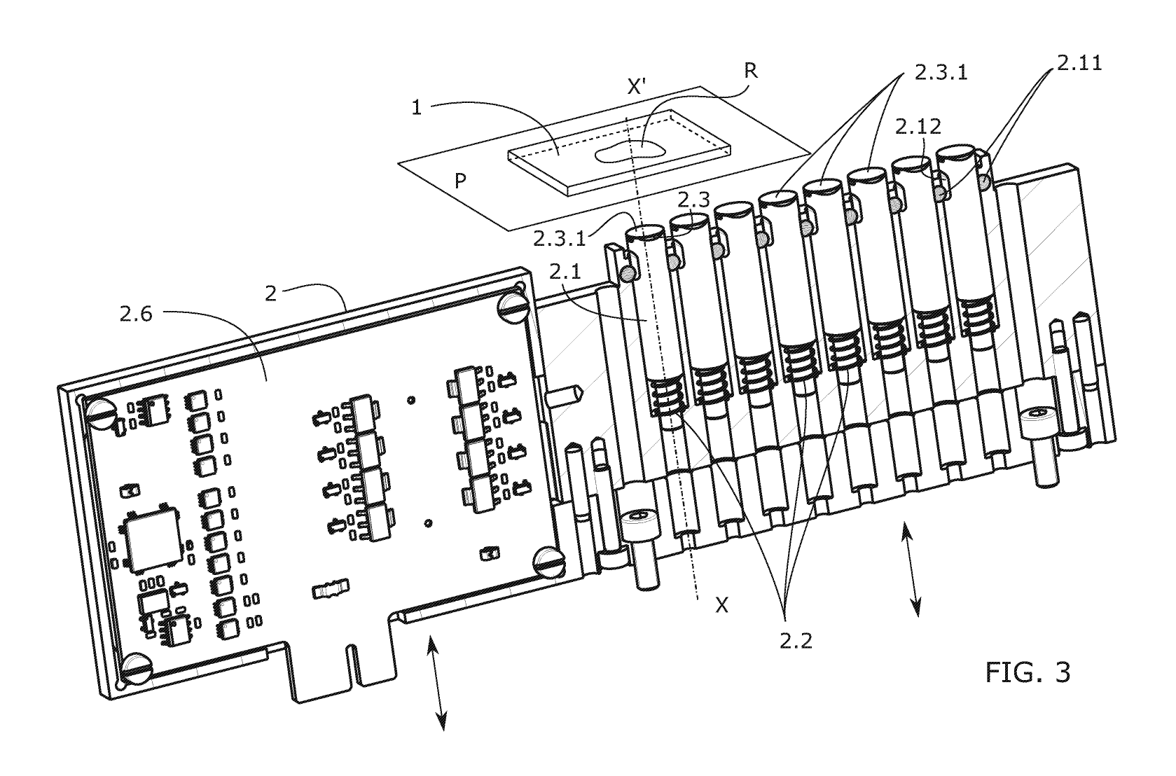

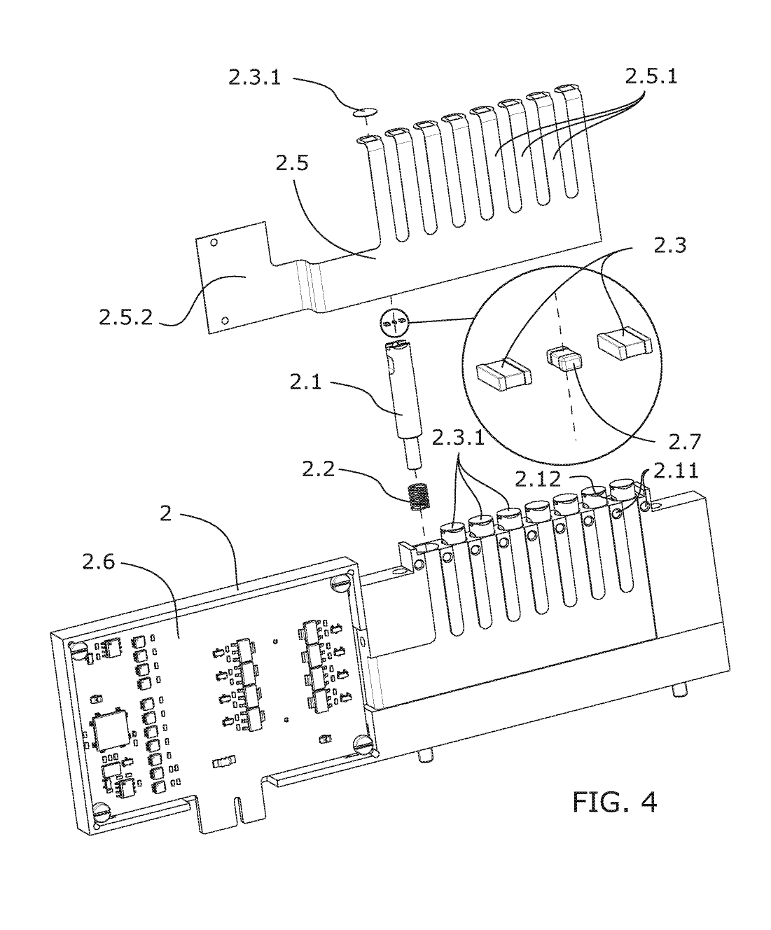

FIGS. 3 and 4 show a second embodiment that has the same components already described in the first embodiment, except in this case the heat source (2.3) consists of resistors for heating a plurality of microfluidic devices (1) or a region (R) thereof. For this reason, the description will emphasize those constructive changes with respect to the example already described based on FIGS. 1 and 2.

This embodiment of the invention is of interest primarily for use for heating one or more microfluidic devices (1) at a constant temperature above room temperature without performing thermal cycling. Although this is the primary interest, it is possible to determine more complicated ways of heating over time.

In this embodiment the temperature changes without the transition time from one temperature to another being important. For example, it is possible to heat the microfluidic device at 90° C. for an hour and to then heat it at 60° C. for 30 minutes. The time it takes to drop from 90° C. to 60° C. is unimportant, such that this embodiment does not have any means for carrying out accelerated cooling.

A microfluidic device (1) can be heated by means of the first embodiment, but this embodiment is less expensive and contains fewer components.

In this embodiment, the movable module (2) contains a plurality of heating units which are in turn formed by a pressure element (2.1), a pressure spring (2.2) located between the pressure element (2.1) and the movable module (2), and a heat source (2.3) formed by two resistors located under the contact surface (2.3.1) formed by a metal plate.

In this embodiment, the pressure element (2.1) is supported on the pressure spring (2.2) by means of a step located in the main body of the pressure element (2.1) and not by means of an intermediate circlip (2.1.2).

The flexible printed circuit board (2.5) puts both the resistors (2.3) generating heat and the temperature sensors (2.7) in electrical communication with the electronic management module (2.6) for powering said resistors (2.3) depending on the temperature that is reached by the contact surface (2.3.1).

The operation of the movable module (2) is similar to that described in the first embodiment. Once the microfluidic device or devices (1) are introduced in the apparatus, the movable module (2) moves towards said microfluidic devices (1) such that the heating units, at least the contact surface (2.3.1) of which projects from the upper surface of the movable module (2), are retracted into the movable module (2). The pressure spring (2.2) is compressed and generates suitable pressure force between the region (R) of the microfluidic device (1) and the contact surface (2.3.1), assuring good thermal contact primarily due to the clearance of the pressure element (2.1) with the movable module (2) in order to allow the region (R) of the microfluidic device (1) and the contact surface (2.3.1) to be co-planar.

The flexible printed circuit board (2.5) allows the resistors (2.3) to be electrically connected to the electronic management module (2.6) shown to the left. The electronic management module (2.6) has temperature readings taken by means of each temperature sensor (2.7) and supplies electrical energy to the heating resistors that provide the necessary heat to the region (R) of the microfluidic devices (1) through the metal plate (2.3.1). In all the embodiments, the metal plate was made of copper. In this embodiment, the metal plate allows heat transfer from the resistors located in the lower portion thereof, where this lower surface is opposite that shown above which contacts the region (R).

In this embodiment, the pressure element (2.1) was preferably made of plastic, materials with low heat conductivity being suitable so that the heat generated in the resistors (2.3) is not transferred to the movable module (2), but rather virtually all of it is transferred to the region (R) of the microfluidic device (1).

To change the temperature of the region (R) of the microfluidic device (1), the electronic management module (2.6) changes the power supplied to the heating resistors (2.3), and the new temperature is reached after a period of time.

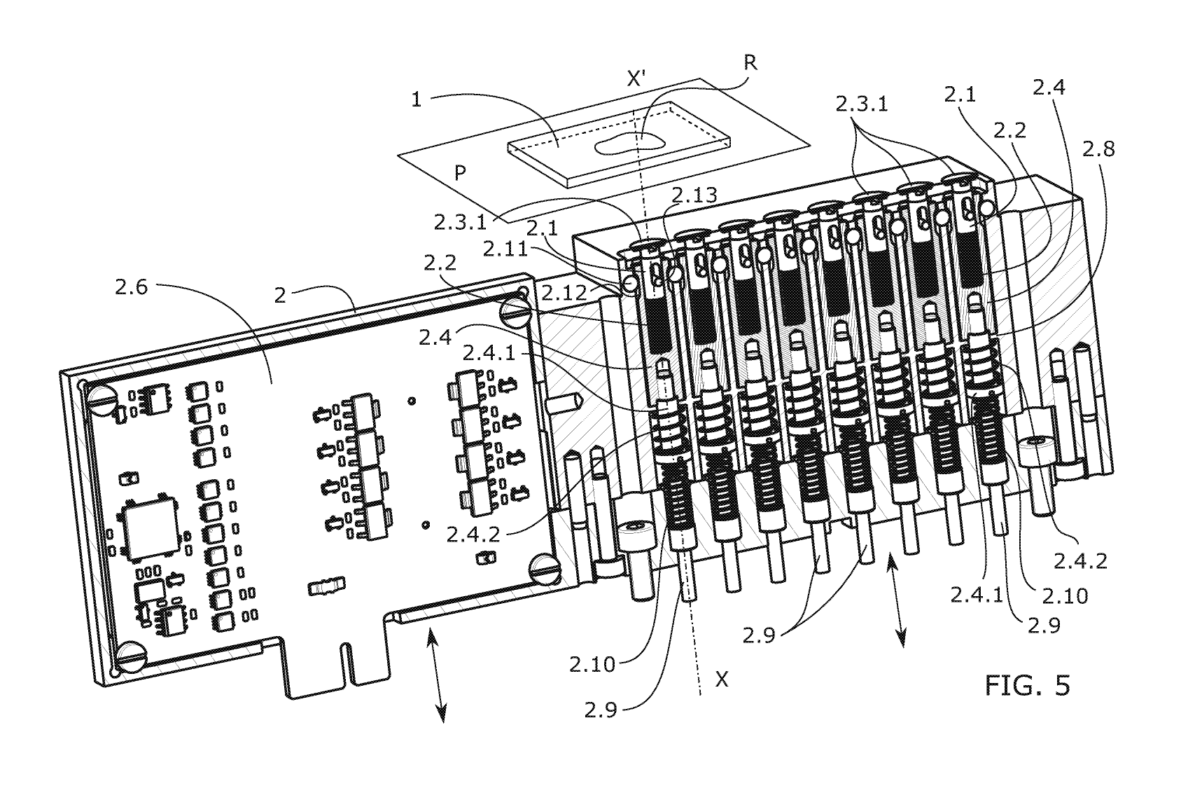

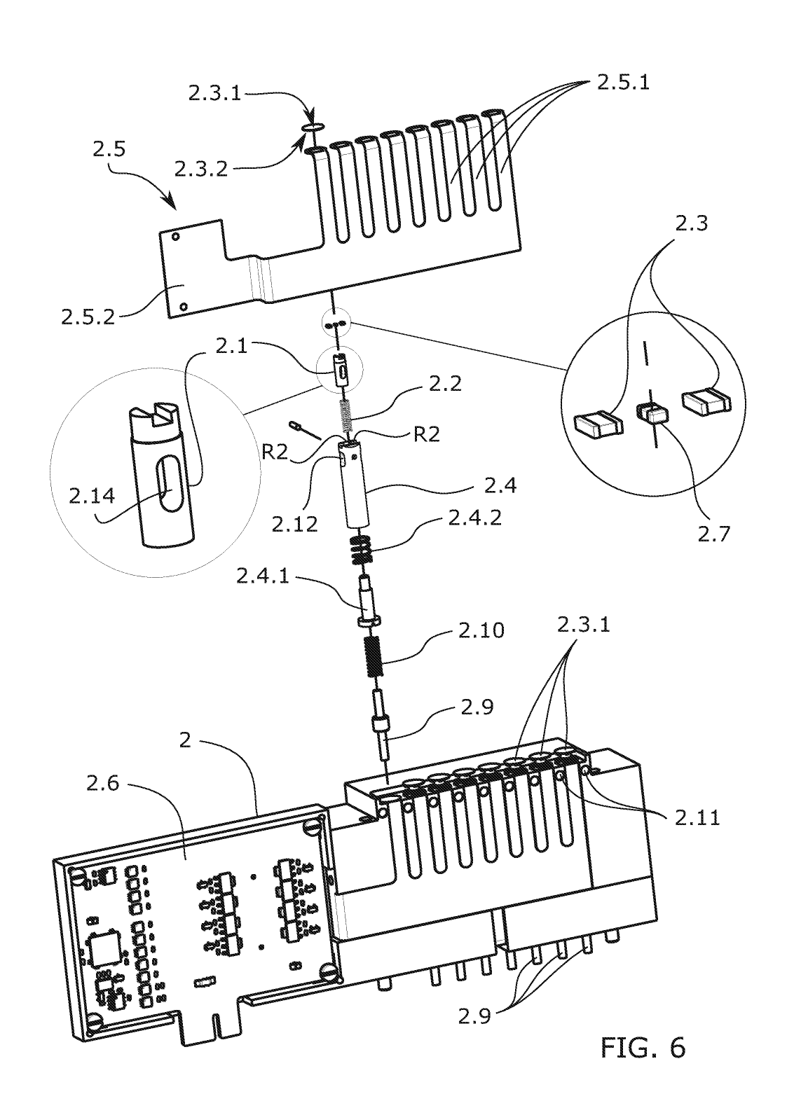

FIGS. 5 and 6 show a third embodiment that is more complex than the preceding embodiments because it allows both heating the region (R) of the microfluidic device (1) and cooling it.

Given that most of the components are common to the preceding examples, the description of this embodiment will place special emphasis on those elements that are different.

The overall operating mode is similar to the preceding examples. Each of the microfluidic devices (1) of the plurality of microfluidic devices that can be handled by the apparatus according to this embodiment is arranged consecutively. The movable module (2) has a plurality of thermal treatment units, where now the thermal treatment unit is capable of heating and of cooling.

In this embodiment, the essential elements of the invention allow heating the region (R) of the microfluidic device (1) and various additional components housing the aforementioned allow cooling.

The configuration is shown in FIG. 5, where the movable module (2) shows an alignment of thermal treatment units, leaving the contact surface (2.3.1) in their upper portion intended for applying pressure on the region (R) of the microfluidic device (1) accessible.

In this embodiment, the movement of the movable module (2) from the separated position to the approaching position is according to direction X-X′ perpendicular to the reference plane (P) defined by the flat area demarcated by the region (R). In this movement, the contact surfaces (2.3.1) contact the regions (R) corresponding to their microfluidic device (1).

In this embodiment, the pressure element (2.1) is smaller than that shown in the preceding examples, and instead of being in direct contact with a cavity of the movable module (2) it is housed in an intermediate part (2.4) having thermal inertia, which is in turn what is housed in direct contact with the cavity of the movable module (2).

The pressure spring (2.2) is located between the pressure element (2.1) and the base of the cavity of the part (2.4) having thermal inertia housing both the pressure spring (2.2) and the pressure element (2.1). This pressure spring (2.2) is what is mainly compressed in the movement of the movable module (2) from the separated position to the approaching position.

The pressure element (2.1) has clearance with respect to the part that directly houses it, i.e., the part (2.4) having thermal inertia, and therefore it also has clearance with respect to the movable module (2).

In the upper portion of the pressure element (2.1) there is a sheet metal integral with the pressure element (2.1), having arranged in its lower portion both resistors acting as heat source (2.3) to generate heat and a temperature sensor (2.7) to send a signal to the electronic management unit (2.6). As in other embodiments, electrical communication for powering the resistors (2.3) and for connecting the temperature sensor (2.7) is by means of a flexible printed circuit board (2.5) which has prolongations (2.5.1) that allow housing both the resistors (2.3) and the sensor (2.7).

The part (2.4) having thermal inertia is movable according to direction X-X′, its movement in the separating direction with respect to the microfluidic device (1) being limited by means of a support seating (2.8). If the part (2.4) having thermal inertia was fixed in this position, contacting the support seating (2.8), the apparatus would behave in a manner similar to the apparatus according to the second embodiment.

In this embodiment, the pressure element (2.1) is smaller and particularly has a smaller diameter, leaving a second contact surface (2.3.2) located opposite the first contact surface (2.3.1) accessible; in this example, the surfaces are in the main surfaces of the sheet metal contacting the region (R) of the microfluidic device (1). The second contact surface (2.3.2) is a perimetral area.

The part (2.4) having thermal inertia shows at its end opposite to where it has the support seating (2.8) a second region (R2) facing the second support surface (2.3.2). The compression of the pressure spring (2.2) keeps these two surfaces, i.e., the second region (R2) and the second support surface (2.3.2), separated even if the movable module (2) is in the end approaching position.

Nevertheless, in this embodiment, the support seating (2.8) has a perforation which allows the passage of a screw (2.4.1) integral with the part (2.4) having thermal inertia passing through the perforation of the support seating (2.8).

Other parts integral with the part (2.4) having thermal inertia are considered equivalents if they carry out the function of allowing easy access by other components from the lower position. The advantage of using a screw (2.4.1) is that a threaded assembly is simple.

Easy access is particularly that of driving means which allow exerting force on the part (2.4) having thermal inertia so that it will move upwards, getting closer to the second region (R) of the part (2.4) having thermal inertia, towards the second contact surface (2.3.2), until contacting both, maximally compressing the pressure spring (2.2).

In this embodiment, a return spring (2.4.2) has been arranged between the head of the screw (2.4.1) and the lower portion of the support seating (2.8) to allow the part (2.4) having thermal inertia to again move away downwards.

The driving means that raise the part (2.4) having thermal inertia are formed by a driving rod (2.9) that is movable in the direction according to the X-X′ axis and contacts the head of the screw (2.4.1), applying upward pressure on it. Contact first occurs with a damper spring (2.10), which is what first starts to transmit the impulse so that it is gentler.

In this embodiment, the pressure element (2.1) is made of an insulating material so that the heat generated by the resistors (2.3) is not transmitted to the part (2.4) having thermal inertia. The function of the part (2.4) having thermal inertia is to cool the metal plate when its second region (R2) contacts the second contact surface (2.3.2). This part (2.4) having thermal inertia has a low temperature so when its second region (R2) contacts the second contact surface (2.3.2), the part cools the region (R) of the microfluidic device (1). In this cooling operation, the resistors (2.3) are disconnected so heat transfer is due solely to the contact of the part (2.4) having inertia and said transfer is for cooling.

In turn, the part (2.4) having thermal inertia is a good heat conductor, and the contact surface with the movable module (2), in this embodiment the surface which allows the guided movement between both components, is also suitable for conducting heat by transferring heat to the mass formed by the movable module (2). As in other embodiments, the movable module (2) can in turn have cooling means that help discharge heat into the atmosphere.

With the alternating application of heat by energizing the resistors (2.3) and of cold by raising the second region (R2) of the part (2.4) having thermal inertia and contacting same with the second contact surface (2.3.2), the temperature is raised and reduced in a short transition time. The heating and cooling alternation allows cycling of the microfluidic devices (1).

The driving rods (2.9) projecting from the lower portion are shown in this embodiment and particularly in FIG. 5. Individual actuation for each microfluidic device (1) or common actuation, for example by means of a single part that applies pressure on all the driving rods (2.9), is possible.

In this embodiment, the actuator is a geared motor and an element for converting rotational movement into linear movement. This detail has not been shown in the drawings.

The movable module (2) can be cooled with radiators, with radiators having interposed Peltier cells for increasing the discharged heat and also with blowers in any of the preceding cases.

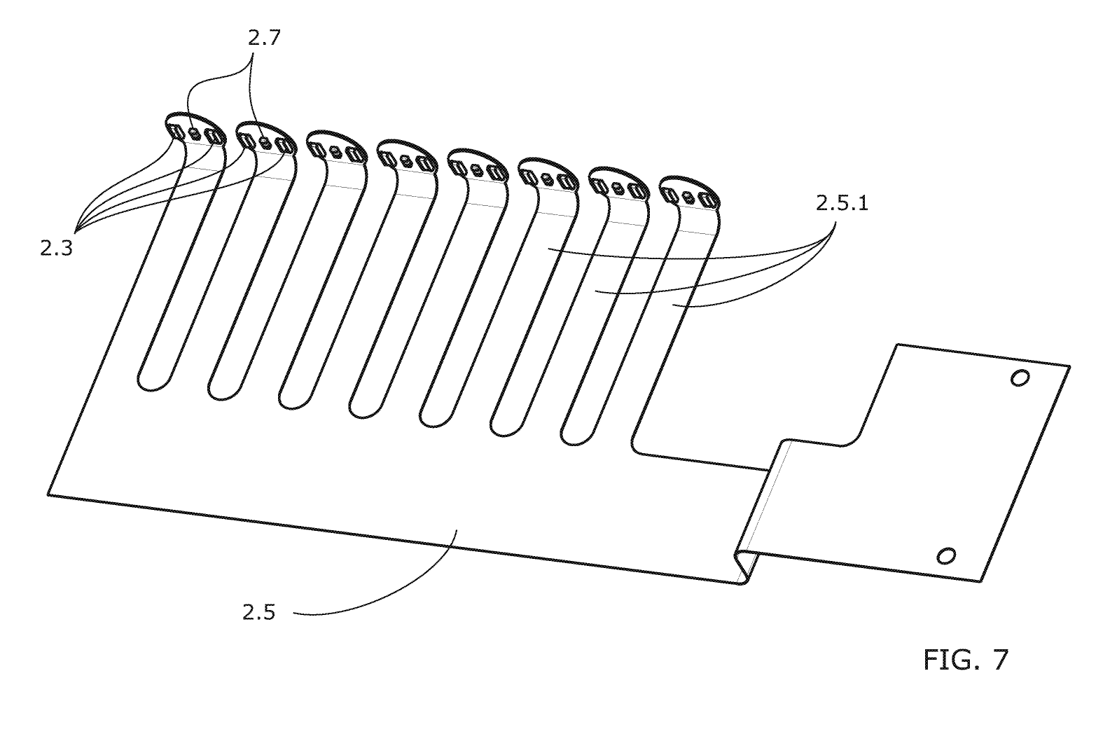

FIG. 7 shows a detail of the position of the resistors (2.3) and of the sensor (2.7) below the metal plate comprising the two contact surfaces (2.3.1, 2.3.2) located in the prolongation (2.5.1) of the flexible printed circuit board (2.5). This configuration of the resistors (2.3) and of the sensor (2.7) when it exists is also the configuration used in the preceding examples.

In some of the described embodiments, the cylindrical parts moving according to direction X-X′ are impeded from rotating in said direction. Particularly in the second embodiment shown in FIGS. 3 and 4, the pressure element (2.1) has two side notches (2.12) which are formed by parallel flat sections at least in a section extending in longitudinal direction X-X′. These parallel flat notches (2.12) are located between two lugs (2.11) such that the lugs (2.11) slide over these surfaces, impeding the pressure element (2.1) from rotating.

This same technical solution is shown in the third embodiment in the part (2.4) having thermal inertia, said part (2.4) having thermal inertia now being the part that has notches (2.11).

In this third example, the rotation of the pressure element (2.1) has also been impeded. The pressure element has a longitudinal groove (2.14) housing another lug (2.13) which impedes the rotation of the pressure element (2.13).

Going back to the third embodiment, once the structure of the apparatus has been seen, its use is now described.

This embodiment allows the apparatus to heat the microfluidic device (1) by performing thermal cycling, i.e., performing cycles with several different temperatures and rapid transitions between each temperature. Heating and cooling means are required for that purpose. All temperatures are above room temperature, so the cooling means are passive means (they do not produce cold). The cooling means are the part (2.4) having thermal inertia; in this embodiment it is a metal part so that it is a good heat conductor that remains at a temperature close to room temperature.

When the part (2.4) having thermal inertia contacts the metal plate comprising both the first contact surface (2.3.1) and the second contact surface (2.3.2), since the part (2.4) having thermal inertia is colder than the metal plate with the resistors (2.3), it rapidly cools said plate, said part (2.4) having thermal inertia in turn being heated. This heat going to the part (2.4) having thermal inertia will gradually be dissipated to the movable module (2) during the rest of the cycle in order to keep the temperature of the part (2.4) having thermal inertia low enough so that it can serve as cooling means in the following cycle.

Once the microfluidic device (1) is introduced in the apparatus, the entire movable module (2) moves towards the microfluidic device (1) such that the metal plates comprising the first contact surface (2.3.1) with the resistors (2.3), which initially project from the upper surface of the movable module (2), are retracted together with the pressure element (2.1) with which they are integral, into the part (2.4) having thermal inertia. The pressure spring (2.2) is compressed and presses the contact surface (2.3.1) against the microfluidic device (1), assuring good thermal contact due to the clearance of the pressure element (2.1) housed inside the part (2.4) having thermal inertia which allows the microfluidic device (1) and the contact surface (2.3.1) to be co-planar and additionally due to the pressure of the pressure spring (2.2).

The pressure element (2.1) is preferably made of a plastic material or any other material having low heat conductivity, so that the resistors (2.3) are thermally insulated from the movable module and the power necessary for obtaining the desired heating temperature is thus reduced.

The part (2.4) having thermal inertia is preferably made of copper or another metal having high heat conductivity, so that it is capable of cooling the metal plate through its second contact surface (2.3.2) as rapidly as possible, and it subsequently dissipates the heat received through said second contact surface (2.3.2) to the movable module (2), thereby keeping it cool for the next cooling.

As in other examples, the flexible printed circuit board (2.5) allows the resistors (2.3) to be connected to the electronic management module (2.6) which is what reads the temperature indicated by the temperature probe (2.7) and supplies electrical energy to the heating resistors (2.3) which heat the microfluidic device (1) through the metal plate which is made of copper in this embodiment.

When the temperature has to be reduced (cooling) in a thermal cycling process which is typical of a PCR reaction, for example, the system proceeds as follows: the electronic management module (2.6) cuts off the electric power supplied to the heating resistors (2.3); the driving means push the driving rod (2.9) upwards, which in turn pushes the screw (2.4.1) upwards; and since the screw (2.4.1) is integral with the part (2.4) having thermal inertia, it moves the latter upwards until it contacts the sheet metal comprising both the first contact surface (2.3.1) and the second contact surface (2.3.2), as well as the lower portion of the heating resistors (2.3), where the resistors (2.3) are located.

Since the part (2.4) having thermal inertia is at a temperature close to room temperature and less than temperature of the metal plate, when said part (2.4) contacts the part (2.4) having thermal inertia it cools rapidly.

When the electronic management module (2.6) detects that the temperature has reached the required value using the temperature sensor (2.7), the apparatus stops applying pressure on the rod (2.9). The rod (2.9) returns to its initial position pushed by the damper spring (2.10) concentric thereto. When this damper spring (2.10) relaxes, the return spring (2.4.2) concentric to the screw (2.4.1) pushes said screw (2.4.1) downwards and the screw (2.4.1) in turn drags the part (2.4) having thermal inertia which no longer contacts the metal plate, the cooling process thereby terminating.

According to any of the embodiments, the apparatus has additional means for improving heat transmission between the contact surface (2.3.1) of the heat source (2.3) and the microfluidic device (1) or a region (R) of said device (1).

The microfluidic device (1) has fluidic inlets, fluidic outlets or both which are in communication with the internal chambers (C), where the chambers (C) are closed by means of an elastically deformable membrane (M).

The additional means for improving heat transmission are coupling means for coupling with the fluidic inlet or inlets and the fluidic outlet or outlets of the microfluidic device as well as pressure increase means for increasing the internal pressure (Pᵢₙₜ) of the chamber (C) such that the elastically deformable membrane (M) coincides with the heat exchange region (R).

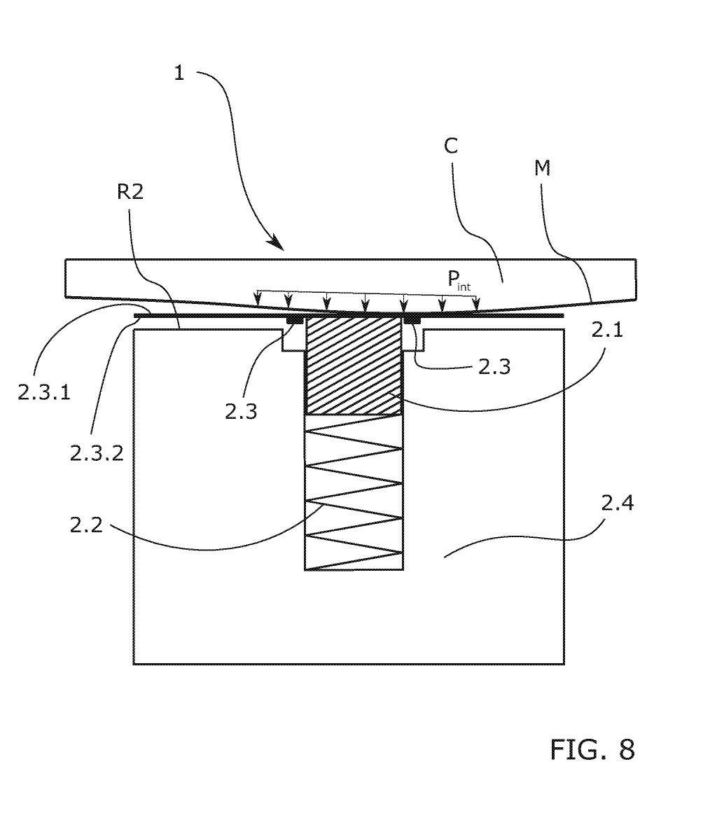

As shown in FIG. 8, the microfluidic device (1) has a chamber (C) closed by means of an elastically deformable membrane (M). When the microfluidic device (1) is in the housing and holding means of the apparatus, the elastically deformable membrane (M) of the microfluidic device (1) is oriented towards the contact surface (2.3.1) of the heat source (2.3). The region of the elastically deformable membrane (M) intended for contacting the contact surface (2.3.1) of the heat source (2.3) is the region identified in the various embodiments as region R.

The increase of the internal pressure (_{Pint}) inside the chamber (C) generates a deformation in the elastically deformable membrane (M) such that said membrane (M) clings to the support surface (2.3.1).

Even though the pressure element (2.1) has clearance to allow being misaligned with respect to direction X-X′, favoring the support between surfaces, this clearance would have the limitation of not achieving complete contact with rigid surfaces having slight deformations with respect to a plane.

The effect of deforming the membrane (M) by means increasing internal pressure (_{Pint}) inside the chamber (C) is to assure contact between the two surfaces (R, 2.3.1) at all the points of the area of contact, assuring homogenous pressure throughout this area, even in the event of slight irregularities on the contact surface (2.3.1), i.e., the surface which is rigid.

FIG. 8 shows the deformation of the membrane (M) due to the effect of the internal pressure (Pᵢₙₜ) inside the chamber (C), said membrane (M) clinging to the contact surface (2.3.1) even with a small gap between the membrane (M) and said contact surface (2.3.1).

In an actual device, the pressure of the contact surface (2.3.1) by the pressure spring (2.2) combined with the internal pressure (Pᵢₙₜ) exerted inside the chamber (C) of the microfluidic device (1) assures optimal contact, even when the contact surface (2.3.1) is irregular, always achieving the same capacity in terms of heat transfer and temperature detection, and a more precise control.

When heating the chamber (C) by means of the resistors and the inlets and outlets of the microfluidic device (1) are closed, additional excess pressure is generated which increases the potentiating effect of repeatability and reproducibility in thermal cycling processes such as PCR (Polymerase Chain Reaction).

Likewise, since the reaction chamber (C) has excess pressure, there is less bubble formation inside the chamber when heated, increasing the potentiating effect of repeatability and reproducibility in thermal cycling processes such as PCR (Polymerase Chain Reaction).

1-13. (canceled)

14. An apparatus for determining a temperature of at least a portion of a microfluidic device having at least one essentially flat region suitable for heat transfer, the apparatus comprising:
a housing member configured to receive and hold the microfluidic device in a certain position and orientation such that the at least one essentially flat region of the microfluidic device establishes a reference plane; and
a movable module that is movable at least according to a direction X-X′ perpendicular to the reference plane, wherein the movement of the movable module according to the direction X-X′ establishes at least one approaching position with respect to the microfluidic device and a separated position with respect to the microfluidic device, wherein the movable module comprises:
a pressure element that is movable according to the direction X-X′, wherein the movement of the pressure element is guided with respect to the movable module, and wherein said pressure element has clearance to allow misalignment with respect to the direction X-X′;
a heat source located in the pressure element, and comprising a first contact surface suitable for being supported on the at least one essentially flat region of the microfluidic device and transferring heat through said at least one essentially flat region when the movable module is in the at least one approaching position with respect to the microfluidic device; and
a compressible pressure spring located between the movable module and the pressure element such that when the movable module is located in the at least one approaching position with respect to the microfluidic device, said pressure spring is compressed, exerting force against the pressure element, and said pressure spring in turn applies pressure on the at least one essentially flat region of the microfluidic device by means of the contact surface.

15. The apparatus according to claim 14, wherein a power supply of the heat source comprises a flexible printed circuit board wherein one end is integral with the pressure element and another end is integral with the movable module to establish electrical communication between the movable module and said heat source without impeding relative movement between the movable module and the heat source.

16. The apparatus according to claim 14, wherein the heat source comprises a Peltier cell located on the pressure element and configured to transfer heat between the first contact surface and the pressure element.

17. The apparatus according to claim 15, wherein the heat source comprises a Peltier cell located on the pressure element and configured to transfer heat between the first contact surface and the pressure element.

18. The apparatus according to claim 16, wherein the Peltier cell is configured to transfer heat from the first contact surface to the pressure element, thereby cooling the first contact surface.

19. The apparatus according to claim 14, wherein the movable module comprises a mass with thermal inertia and the pressure element is suitable for transferring heat between the heat source and the movable module, such that said pressure element comprises a heat conductive material and is guided by sliding of a cylindrical perimetral surface over a complementary guiding surface arranged in the movable module, with contact between the cylindrical perimetral surface and the complementary guiding surface being suitable for conducting heat therebetween.

20. The apparatus according to claim 15, wherein the movable module comprises a mass with thermal inertia and the pressure element is suitable for transferring heat between the heat source and the movable module, such that said pressure element comprises a heat conductive material and is guided by sliding of a cylindrical perimetral surface over a complementary guiding surface arranged in the movable module, with contact between the cylindrical perimetral surface and the complementary guiding surface being suitable for conducting heat therebetween.

21. The apparatus according to claim 14, wherein the heat source comprises a heat dissipation resistor for heating the first contact surface.

22. The apparatus according to claim 21, wherein the pressure element comprises a heat insulating material.

23. The apparatus according to claim 21, wherein the pressure element and the pressure spring are housed in a part having thermal inertia and being movable in the direction X-X′ with respect to the movable module, such that:
the pressure element is movable in the direction X-X′ with respect to the part having thermal inertia, wherein said pressure element has clearance with a housing of the part having thermal inertia to allow misalignment with respect to direction X-X′, and the pressure spring is located between the pressure element and the part having thermal inertia,
the movable module comprises a support seating configured to limit movement of the part having thermal inertia in a direction corresponding to separation with respect to the at least one essentially flat region of the microfluidic device,
the part having thermal inertia comprises a heat transfer region,
the heat source comprises a second contact surface arranged opposite the first contact surface, the second contact surface configured to be supported on the at least one essentially flat region of the microfluidic device, and wherein the second contact surface is configured to receive a contact support of the heat transfer region of the part having thermal inertia and exchange heat through said contact support, and
the first contact surface is in thermal communication with the second contact surface, and the part having thermal inertia has at least one driving member configured to force the contact support between the heat transfer region and the second contact surface of the heat source.

24. The apparatus according to claim 23, wherein the movable module comprises a mass with thermal inertia and the part having thermal inertia is suitable for transferring heat between the movable module and the heat transfer region, such that said part having thermal inertia comprises a heat conductive material and is guided by sliding of a cylindrical perimetral surface over a complementary guiding surface arranged in the movable module, with contact between the cylindrical perimetral surface and the complementary guiding surface being suitable for conducting heat therebetween.

25. The apparatus according to claim 24, wherein the part having thermal inertia has a screw-return spring assembly such that:
a screw is located opposite the heat transfer region retaining a return spring between said screw and the part having thermal inertia,
the support seating configured to limit movement of the part having thermal inertia is interposed between the return spring and the part having thermal inertia, and
the at least one driving member acts on the screw.

26. The apparatus according to claim 14, wherein the apparatus comprises at least one control element configured to generate movement orders comprising:
moving the movable module from the separated position to the at least one approaching position with respect to the at least one essentially flat region of the microfluidic device,
powering the heat source, and
separating the movable module.

27. The apparatus according to claim 15, wherein the apparatus comprises at least one control element configured to generate movement orders comprising:
moving the movable module from the separated position to the at least one approaching position with respect to the at least one essentially flat region of the microfluidic device,
powering the heat source, and
separating the movable module.

28. The apparatus according to claim 19, wherein the apparatus comprises at least one control element configured to generate movement orders comprising:
moving the movable module from the separated position to the at least one approaching position with respect to the at least one essentially flat region of the microfluidic device,
powering the heat source, and
separating the movable module.

29. The apparatus according to claim 14, wherein said apparatus is suitable for acting on the microfluidic device wherein:
the microfluidic device comprises fluidic inlets and/or fluidic outlets that are in fluidic communication with at least one internal chamber, wherein said at least one internal chamber is selectively closed by means of an elastically deformable membrane, an outer surface of the elastically deformable membrane closing the at least one internal chamber comprises the at least one essentially flat region suitable for contacting the first contact surface of the heat source,
wherein the apparatus comprises at least one coupling element configured to couple with the fluidic inlets and/or the fluidic outlets which are in fluidic communication with the at least one internal chamber of the microfluidic device, and comprises at least one pressure increase element configured to increase an internal pressure of the at least one internal chamber to improve contact between the first contact surface and the outer surface of the elastically deformable membrane selectively closing the at least one internal chamber.

31. A system comprising an apparatus according to claim 14 and a microfluidic device.

32. A system comprising an apparatus according to claim 15 and a microfluidic device.

32. A system comprising an apparatus according to claim 19 and a microfluidic device.
